(19) United States
(12) Patent Application Publication
(10) Pub. No.: US 2025/0135455 A1
(43) Pub. Date: May 1, 2025

(54) ASSAY DEVICE

(71) Applicant: NATIONAL INSTITUTE OF ADVANCED INDUSTRIAL SCIENCE AND TECHNOLOGY, Tokyo (JP)

(72) Inventors: Yusuke FUCHIWAKI, Takamatsu-shi, Kagawa (JP); Masato TANAKA, Takamatsu-shi, Kagawa (JP); Shohei YAMAMURA, Takamatsu-shi, Kagawa (JP)

(21) Appl. No.: 18/683,222

(22) PCT Filed: Jul. 27, 2022
(86) PCT No.: PCT/JP2022/028952

§ 371 Date: Feb. 12, 2024

(30) Foreign Application Priority Data
Aug. 16, 2021 (JP) 2021-132349

(51) Int. Cl. B01L 3/00

(52) U.S. Cl. CPC B01L 3/502715; B01L 2200/16; B01L 2300/0816; B01L 2300/0864; B01L 2300/168

(57) ABSTRACT

An assay device includes an inlet; an inner flow passage through which a liquid injected from the inlet flows; and a liquid absorbing material that absorbs the liquid that has passed through the inner flow passage. The inner flow passage include a microflow passage that includes an assay region and a separating flow passage that is provided between the microflow passage and the liquid absorbing material for separating the liquid therein when injection of the liquid is stopped, and the separating flow passage includes a narrowed width portion with a narrowed flow passage width.

### TECHNICAL FIELD

The present invention relates to an assay device, and particularly to an assay device capable of performing an assay using a small amount of liquid.

### BACKGROUND ART

An assay device described in Patent Document 1 is known as an example of assay devices in the related art of this type. The assay device described in Patent Document 1 includes a microflow passage configured to allow fluid to flow, an absorbing porous medium disposed at a distance from one end of the microflow passage, the one end being positioned at one end in a flow direction of the fluid, a separating space disposed between the one end of the microflow passage and the absorbing porous medium, and two sideways ventilation passages being adjacent to both sides of the microflow passage, respectively in a width direction orthogonal to the flow direction, the two sideways ventilation passages being communicated with the microflow passage to allow air circulation.

### CITATION LIST

### Patent Literature

Patent Document 1: International Publication No. WO 2020/045551 A1

### SUMMARY OF INVENTION

### Problem to be Solved by the Invention

According to the assay device described in Patent Document 1, it is possible to replace a liquid inside the microflow passage from a first liquid to a second liquid, that is, it is possible to perform replacement of liquid inside the microflow passage by an amount of second liquid exceeding the amount of first liquid being injected into the microflow passage when the microflow passage is filled with the first liquid.

However, in a case of a liquid with a small interfacial tension, there is a concern that the liquid cannot stably stay inside the microflow passage. If the liquid does not stably stay inside the microflow passage, it is difficult for the liquid to maintain a stable shape inside the microflow passage. As a result, replacement of the liquid inside the microflow passage cannot be stably performed due to mixture of air inside the microflow passage or the like.

Here, there is a trend that sample solutions (extracted solutions and the like) in biochemical tests have small interfacial tensions because relatively large amounts of surfactant are contained in many cases and due to influences of a blocking agent used for a blocking treatment of the surface of the microflow passage. Also, multi-stage reactions as in enzyme-linked immunosorbent assay (ELISA) may be needed for treatments of sample solutions in biochemical tests. For these reasons, there has been a demand to stably perform replacement of a liquid inside the microflow passage particularly in a case where a sample solution in a biochemical test is used.

Note that such a demand is not limited to a case where a sample solution in a biochemical test is used and is common to a case where a liquid with a relatively small interfacial tension is used.

Thus, an object of the present invention is to provide an assay device that enables a liquid to be stably replaced inside a microflow passage even in a case of a liquid with a relatively small interfacial tension and a microflow passage with an interfacial tension weakened due to a surface treatment such as a blocking treatment.

### Means for Solving the Problems

According to an aspect of the present invention, there is provided an assay device including: an inlet; an inner flow passage through which a liquid injected from the inlet flows; and a liquid absorbing material that absorbs the liquid that has passed through the inner flow passage. In the provided assay device, the inner flow passage includes a microflow passage that includes an assay region and a separating flow passage that is provided between the microflow passage and the liquid absorbing material for separating the liquid inside the inner flow passage when injection of the liquid is stopped, and the separating flow passage includes a narrowed width portion with a narrowed flow passage width.

### Advantageous Effects of Invention

According to the present invention, it is possible to provide an assay device that enables a liquid to be stably replaced inside a microflow passage even in a case of a liquid with a relatively small interfacial tension and a microflow passage with an interfacial tension weakened due to a surface treatment such as a blocking treatment.

### BRIEF DESCRIPTION OF DRAWINGS

FIG. 1 is a perspective view of an assay device according to a first embodiment.

FIG. 2 is a sectional view of the assay device according to the first embodiment.

FIG. 3 is an exploded perspective view of the assay device according to the first embodiment.

FIG. 4 is a diagram illustrating an upper flow passage forming member, in which FIG. 4A is a top view of the upper flow passage forming member, FIG. 4B is a side view of the upper flow passage forming member, and FIG. 4C is a bottom view of the upper flow passage forming member.

FIG. 5 is a diagram illustrating a lower flow passage forming member, in which FIG. 5A is a top view of the lower flow passage forming member, FIG. 5B is a side view of the lower flow passage forming member, FIG. 5C is a bottom view of the lower flow passage forming member, and FIG. 5D is a sectional view along A-A in FIG. 5A.

FIG. 6 is a diagram illustrating an intermediate member disposed between the upper flow passage forming member and the lower flow passage forming member, in which FIG. 6A is a top view of the intermediate member, and FIG. 6B is a side view of the intermediate member.

FIG. 7 is a diagram for explaining an inner flow passage and an inner ventilation space, in which FIG. 7A mainly illustrates an upper portion of the inner flow passage, and FIG. 7B mainly illustrates a lower portion of the inner flow passage.

FIG. 8 is a diagram illustrating an assay device before an upper cover is attached and when a blocking treatment is performed on the inner flow passage.

FIG. 9 is a diagram for explaining motion of a first liquid injected into the assay device and is a diagram schematically illustrating the inner flow passage and the like when the assay device is seen from above.

FIG. 10 is a diagram for explaining motion of the first liquid and a second liquid when the second liquid is injected after injection of the first liquid into the assay device is stopped and is a diagram schematically illustrating the inner flow passage and the like when the assay device is seen from above.

FIG. 11 is a diagram for explaining a modification of the assay device according to the first embodiment.

FIG. 12 is a perspective view of an assay device according to a second embodiment.

FIG. 13 is an exploded perspective view of the assay device according to the second embodiment.

### MODE FOR CARRYING OUT THE INVENTION

Hereinafter, an assay device according to embodiments of the present invention will be described.

The assay device according to the embodiments is a device with which it is possible to perform an assay using a small amount of liquid. A liquid that can be used by the assay device according to the embodiments may be any liquid as long as the liquid can flow through a flow passage (inner flow passage) provided inside the assay device and is not particularly limited. Such a liquid is typically an aqueous solution. Also, the liquid that can be used in the assay device according to the embodiments includes not only a chemically pure liquid but also a liquid in which gas, another liquid, or a solid is dissolved, dispersed, or suspended.

For example, a liquid of a biological origin may be used. In a case where a liquid of a biological origin is used, it is possible to measure a specimen that is effective for diagnosis in the liquid for applications such as a pregnancy test, urinalysis, a stool test, an adult disease test, an allergy test, an infectious disease test, a drug test, and a cancer test with the assay device. Also, a suspension of food, drink water, river water, a soil suspension, and the like may be used. In a case where these are used, it is possible to measure pathogens in the food or the drink water or it is possible to measure contamination substances in the river water or the soil.

In the present specification, the “specimen” mainly refers to a compound or a composition that is detected or measured using the liquid. Examples of the “specimen” include saccharides (glucose, for example), cells, protein or peptide (serum protein, hormone, enzyme, immune regulators, lymphokine, monokidney, cytokine, glycoprotein, vaccine antigens, antibodies, growth factors, and proliferative factors, for example), fat, amino acids, nucleic acids, steroids, vitamins, pathogens or antigens thereof, natural substances or synthetic chemical substances, contamination substances, therapeutic drugs or illegal drugs, and metabolites or antibodies of these substances.

Also, a “microflow passage” in the present specification refers to a flow passage inside the assay device that enables the specimen to be detected or measured using a very small amount of liquid of microliter (μl) order, that is, a liquid in amount that is as very small as not less than 1 μl and less than 1000 μl.

### First Embodiment

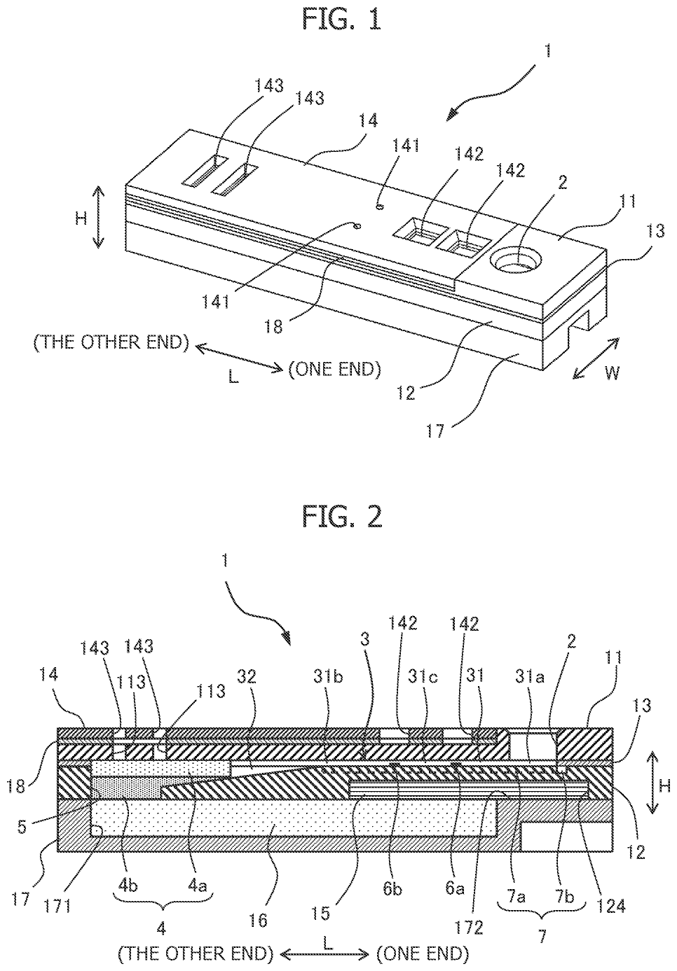

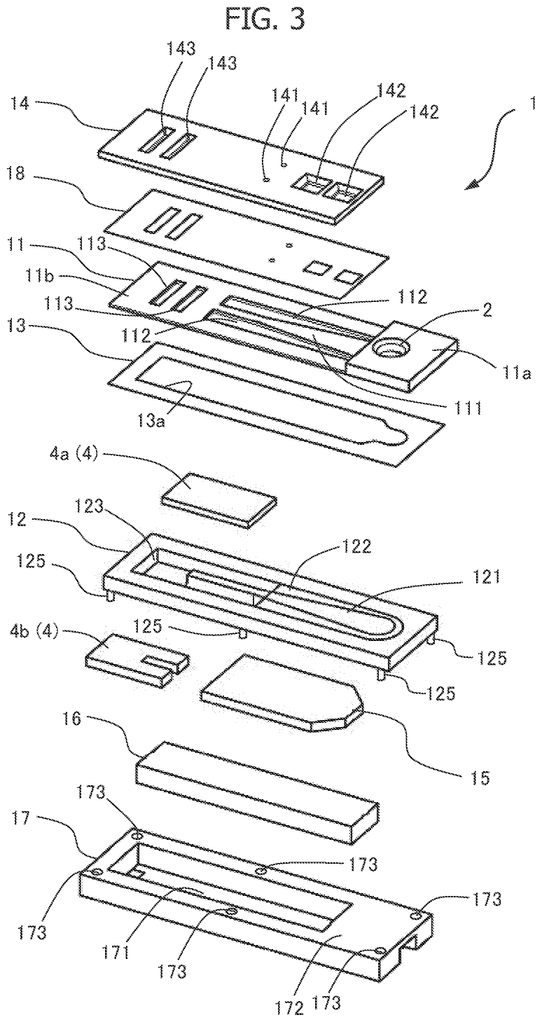

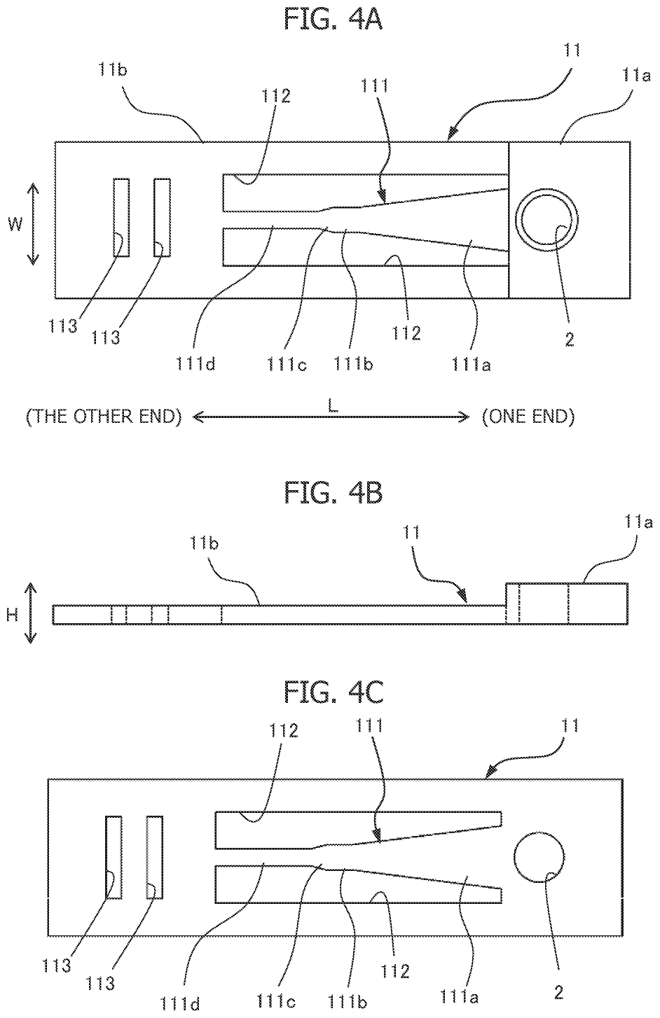

FIGS. 1 to 3 illustrate an assay device 1 according to a first embodiment. FIG. 1 is a perspective view of the assay device 1, FIG. 2 is a sectional view of the assay device 1, and FIG. 3 is an exploded perspective view of the assay device 1.

First, a basic configuration of the assay device 1 will be described.

The assay device 1 is formed into substantially a rectangular parallelepiped shape as a whole and includes an inlet 2, into which a liquid is injected (mainly injected in a dropwise manner), at one end (the right side in FIG. 2) in a longitudinal direction L. The inlet 2 is formed into a circular shape and opens in an upper surface of the assay device 1. However, the shape of the inlet 2 is not limited to the circular shape and may be any shape such as an oval shape or a polygonal shape.

Also, the assay device 1 includes an inner flow passage 3 through which the liquid injected from the inlet 2 flows and a first liquid absorbing material 4 that absorbs the liquid that has passed through the inner flow passage 3. The inner flow passage 3 extends in the longitudinal direction L inside the assay device 1. The first liquid absorbing material 4 is formed by a porous material or the like that can absorb the liquid and is housed in a housing space 5 provided at the other end (the left side in FIG. 2) in the longitudinal direction L inside the assay device 1. In other words, the longitudinal direction L is also a flowing direction of the liquid inside the assay device 1. In this case, the one end in the longitudinal direction L where the inlet 2 is located is upstream, while the other end in the longitudinal direction L where the first liquid absorbing material 4 is located is downstream.

In the present embodiment, the first liquid absorbing material 4 includes an upper absorbing material 4a and a lower absorbing material 4b. However, the first liquid absorbing material 4 is not limited thereto, may include one absorbing material, or may include three or more absorbing materials.

In the present embodiment, the inner flow passage 3 includes an upper wall and a lower wall as is also obvious from FIG. 2. Furthermore, in the present embodiment, the inner flow passage 3 is defined by the upper wall and the lower wall and does not include any side walls. Also, the inner flow passage 3 includes a microflow passage 31 and a separating flow passage 32.

The microflow passage 31 constitutes an upstream-side flow passage of the inner flow passage 3, that is, a flow passage close to the inlet 2. A base end portion (upstream end) 31a of the microflow passage 31 is located in the vicinity of the inlet 2, specifically, within a range in which it is possible to receive a liquid injected from the inlet 2. Preferably, the base end portion 31a of the microflow passage 31 is located below (furthermore, right below) the inlet 2. The microflow passage 31 extends substantially horizontally from the base end portion 31a toward the other end in the longitudinal direction L, and a distal end portion (downstream end) 31b of the microflow passage 31 is located substantially at the center of the assay device 1 in the longitudinal direction L.

An assay region 31c is provided at an intermediate portion of the microflow passage 31, that is, between the base end portion 31a and the distal end portion 31b of the microflow passage 31. One or more assay reagents may be disposed in the assay region 31c. The assay reagent is any substance that can lead to a detectable result by reacting with a liquid or a specimen contained therein and may be an antibody or an antigen, for example. Although it is preferable that the detectable result can be visually recognized by an observer with naked eyes, the detectable result is not limited thereto. The detectable result may be a result that allows visual recognition or the like by the observer using a predetermined device. The detectable result includes coloring, light absorbance, light emission, fluorescence, and the like.

In the present embodiment, a first assay reagent 6a and a second assay reagent 6b are disposed to be separated from each other in the longitudinal direction L in the assay region 31c. Specifically, the first assay reagent 6a and the second assay reagent 6b are fixed to either one of the lower wall and the upper wall or both the lower wall and the upper wall of the microflow passage 31 in the present embodiment. However, the first assay reagent 6a and the second assay reagent 6b are not limited thereto. The first assay reagent 6a and/or the second assay reagent 6b may be carried by a porous material or the like that allows the liquid to pass therethrough, and the porous element (carrier) may be installed in the assay region 31c.

The separating flow passage 32 constitutes a downstream flow passage of the inner flow passage 3, that is, a flow passage close to the first liquid absorbing material 4. One end (upstream end) of the separating flow passage 32 is connected to the distal end portion (downstream end) 31b of the microflow passage 31. The separating flow passage 32 extends from the one end connected to the distal end portion 31b of the microflow passage 31 toward the other end in the longitudinal direction L, and the other end (downstream end) of the separating flow passage 32 is in contact with the first liquid absorbing material 4.

In other words, in the present embodiment, the first liquid absorbing material 4 is provided to be separated from the distal end portion (downstream end) 31b of the microflow passage 31 in the longitudinal direction L, and the separating flow passage 32 is provided between (the distal end portion 31b of) the microflow passage 31 and the first liquid absorbing material 4. The separating flow passage 32 is configured to separate the liquid inside the inner flow passage 3 when injection of the liquid into the inlet 2 is stopped, in other words, when supply of the liquid to the inner flow passage 3 is stopped as will be described later. Specifically, the liquid inside the inner flow passage 3 is divided in the separating flow passage 32 when the injection of the liquid into the inlet 2 is stopped, a part thereof is absorbed by the first liquid absorbing material 4, and the rest stays (is left) inside the microflow passage 31.

Furthermore, an inner ventilation space 7 that communicates with outside of the assay device 1 is provided inside the assay device 1. The inner ventilation space 7 is formed to surround a most part of the microflow passage 31. More specifically, in a top view, the inner ventilation space 7 is formed to surround the periphery of the most part of the microflow passage 31 except for the distal end portion 31b of the microflow passage 31 to which the one end (upstream end) of the separating flow passage 32 is connected. As described above, the inner flow passage 3 does not include any side walls in the present embodiment. Therefore, the inner ventilation space 7 also communicates with the microflow passage 31. In addition, in the present embodiment, the inner ventilation space 7 includes a pair of sideways spaces 7a and 7a (only one of them is illustrated by a dashed line in FIG. 2) and a coupling space 7b that couples the pair of sideways spaces 7a and 7a. The pair of sideways spaces 7a and 7a are adjacent to the microflow passage 31 on both sides in a lateral direction (hereinafter, referred to as a “width direction”) and communicate with the microflow passage 31. The coupling space 7b is formed into an arc shape to extend along an outer edge of the inlet 2, one end portion of the coupling space 7b is connected to one sideways space 7a, and the other end portion of the coupling space 7b is connected to the other sideways space 7a. Note that the communication between the inner ventilation space 7 and the outside will be described later.

Referring to FIG. 2, in the present embodiment, the upper wall and the lower wall of the microflow passage 31 extend substantially horizontally, and the height of the microflow passage 31, that is, the distance between the upper wall and the lower wall of the microflow passage 31 in a height direction H is constant (This is not necessarily constant in a strict sense and may be substantially constant. The same applies to the following description) in the present embodiment. Also, the height of the microflow passage 31 is defined such that an interfacial tension of the liquid with which leakage to the inner ventilation space 7 (particularly to the pair of sideways spaces 7a and 7a on both sides of the microflow passage 31) can be prevented when the liquid flows through the microflow passage 31 can be generated. On the other hand, the upper wall of the separating flow passage 32 is configured with the upper wall of the microflow passage 31 being extended as it is and extends substantially horizontally, and the lower wall of the separating flow passage 32 is inclined downward such that the height position becomes lower at a greater distance from (the distal end portion 31b of) the microflow passage 31, that is, as it approaches the first liquid absorbing material 4. The angle of the downward inclination of the lower wall of the separating flow passage 32 may be freely set within a range of 1° to 45° with respect to the horizontal direction and is preferably set to 2° to 10°.

Here, although not particularly limited, the height of the microflow passage 31 may be set within a range of 1 μm to 1 mm, for example, the width (the dimension in the width direction W) of the microflow passage 31 may be set within a range of 100 μm to 1 cm, for example, and the length (the dimension in the longitudinal direction L) of the microflow passage 31 may be set within a range of 10 μm to 10 cm, for example.

In a case where the liquid is a specimen liquid in a biochemical test, in particular, it is preferable to perform a blocking treatment, a plasma treatment, or the like for preventing nonspecific adsorption of substances of biological origin, antigens, antibodies, and the like on the surface of the inner flow passage 3 (the microflow passage 31 and the separating flow passage 32) with which the liquid comes into contact. Although a blocking agent used for the blocking treatment includes commercially available blocking agents, bovine serum albumin, casein, skim milk, gelatin, a surfactant, polyvinyl alcohol, globulin, serum (fetal bovine serum or normal rabbit serum, for example), ethanol, an MPC polymer, and the like, and the commercially available blocking agents include ImmunoBlock, Block Ace, Pierce Blocking Buffer, StartingBlock, StabilGuard, StabilBrock, StabilCoat, ChonBlock, and the like, the blocking agent is not limited thereto.

The inner flow passage 3 and the inner ventilation space 7 will be further described.

In the present embodiment, the inner flow passage 3 and the inner ventilation space 7 are formed by the upper flow passage forming member 111, the lower flow passage forming member 12, and an intermediate member 13 functioning as a spacer therebetween being stacked. Hereinafter, the upper flow passage forming member 11, the lower flow passage forming member 12, and the intermediate member 13 will be described in this order.

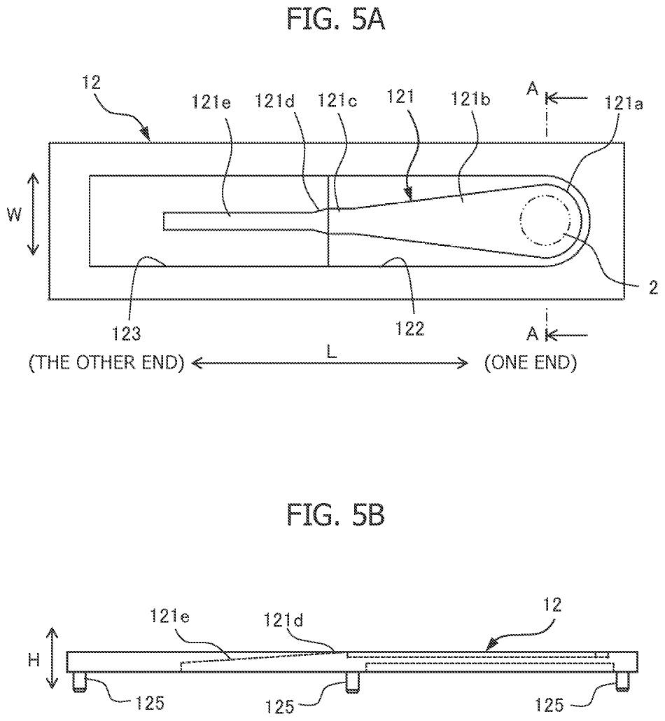

FIG. 4 illustrates the upper flow passage forming member 11. FIG. 4A is a top view of the upper flow passage forming member 11, FIG. 4B is a side view of the upper flow passage forming member 11, and FIG. 4C is a bottom view of the upper flow passage forming member 11.

In the present embodiment, the upper flow passage forming member 11 is made of a transparent synthetic resin and is formed to have flexibility to some extent. Preferably, the upper flow passage forming member 11 is configured with a molded article of a transparent synthetic resin. Although examples of such a synthetic resin includes a PS resin (polystyrene), PMMA (acrylic resin), PC (polycarbonate), COP (cycloolefin polymer), COC (cycloolefin copolymer), an ABS resin, an AS resin, and a silicone resin, the synthetic resin is not limited thereto. Although not limited, a contact angle of the surface of the upper flow passage forming member 11 is preferably not more than 90 degrees with respect to water.

Referring to FIGS. 4A to 4C, the upper flow passage forming member 11 has an outer shape formed into a rectangular shape in a top view. Also, the upper flow passage forming member 11 has a larger dimension in the height direction H than the other parts, and in other words, the upper flow passage forming member 11 has a thicker thickness, in a predetermined range at the one end in the longitudinal direction L. Hereinafter, the part with a larger size (the thicker thickness) in the height direction H at the one end in the longitudinal direction L will be referred to as a thick portion 11a, and the remaining part that is thinner than the thick portion 11a will be referred to as a thin portion 11b.

The inlet 2 is formed at the thick portion 11a of the upper flow passage forming member 11. The inlet 2 penetrates through the thick portion 11a in the height direction H. In other words, the inlet 2 opens, at its one end, in the upper surface of the thick portion 11a of the upper flow passage forming member 11 and opens, at the other end, in the lower surface of the thick portion 11a. The inlet 2 is formed at the center of the thick portion 11a in the width direction W and at a position near the thin portion 11b in a top view.

An upper wall portion 111 constituting the upper wall of the inner flow passage 3 along with a part (the peripheral portion of the inlet 2) of the thick portion 11a and a pair of first opening portions 112 and 112 sandwiching the upper wall portion 111 therebetween in the width direction W are formed at the thin portion 11b of the upper flow passage forming member 11. The upper wall portion 111 extends from an end portion of the thin portion 11b on the side of the thick portion 11a (the boundary with the thick portion 11a), that is, from the vicinity of the inlet 2 toward the other end in the longitudinal direction L. The pair of first opening portions 112 and 112 are symmetrically formed. Each of the pair of first opening portions 112 and 112 extends in the longitudinal direction L along a side edge of the upper wall portion 111 and penetrates through the thin portion 11b of the upper flow passage forming member 11 in the height direction. In other words, the pair of first opening portions 112 and 112 separated from each other in the width direction W and penetrating through the thin portion 11b in the height direction H are formed at the thin portion 11b of the upper flow passage forming member 11, and the part between the pair of first opening portions 112 and 112 in the thin portion 11b of the upper flow passage forming member 11 constitutes the upper wall portion 111.

In the present embodiment, the upper wall portion 111 includes an upper tapered portion 111a, a first upper straight portion 111b, an upper narrowed width portion 111c, and a second upper straight portion 111d in the order from the one end in the longitudinal direction, that is, from closest to the inlet 2.

The upper tapered portion 111a extends from the end of the thin portion 11b on the side of the thick portion 11a, that is, from the vicinity of the inlet 2 toward the other end in the longitudinal direction L. Also, the upper tapered portion 111a is formed into a tapered shape with a width gradually narrowed (the dimension in the width direction W gradually reduced) at a greater distance from the inlet 2. Although not particularly limited, the taper angle of the upper tapered portion 111a is set to 1° to 20°, or is preferably set to 2° to 16°. In other words, the angle that each of both side portions of the upper tapered portion 111a with respect to a straight line that is parallel with the longitudinal direction L is set to 0.5° to 10°, or is preferably set to 1° to 8°. Alternatively, a ratio between the dimension of the upper tapered portion 111a in the width direction W on the side of the inlet 2 and the dimension of the upper tapered portion 111a in the width direction W on the side of the first upper straight portion 111b, that is, the dimension ratio between the upstream portion and the downstream portion of the upper tapered portion 111a in the width direction is set to 1:0.99 to 1:0.2.

The first upper straight portion 111b has the same width as the width of the distal end portion of the upper tapered portion 111a and linearly extends from the distal end portion of the upper tapered portion 111a toward the other end in the longitudinal direction L. The width of the first upper straight portion 111b is constant. The distal end portion of the first upper straight portion is located substantially at the center in the longitudinal direction L.

The upper narrowed width portion 111c means a part of the upper wall portion 111 where the width is narrowed. In the present embodiment, the upper narrowed width portion 111c couples the first upper straight portion 111b to the second upper straight portion 111d. Specifically, the second upper straight portion 111d is formed to have a narrowed width than the first upper straight portion 111b in the present embodiment. Also, the upper narrowed width portion 111c is formed into a tapered shape in which the width thereof is gradually narrowed from the width of the first upper straight portion 111b to the width of the second upper straight portion 11d, and couples the first upper straight portion 111b to the second upper straight portion 111d. The taper angle of the upper narrowed width portion 111c may be freely set and is preferably set to be not more than the taper angle of the upper tapered portion 111a. However, the taper angle of the upper narrowed width portion 111c is not limited thereto. It is only necessary for the upper narrowed width portion 111c to be a part of the upper wall portion 111 where the width is narrowed, and the upper narrowed width portion 111c may be configured into a shape with one or more steps or a plurality of tapered shapes.

The second upper straight portion 111d is formed to have a narrower width than the first upper straight portion 111b as described above and linearly extends from the upper narrowed width portion 111c toward the other end in the longitudinal direction L. The width of the second upper straight portion 111d is constant.

Also, through-holes 113 and 113 with a rectangular shape that is long in the width direction W are formed at the thin portion 11b of the upper flow passage forming member 11. The through-holes 113 and 113 are provided to be separated from each other in the longitudinal direction L at positions separated from the distal end portion of (the second upper straight portion 111d of) the upper wall portion 111 at the other end in the longitudinal direction L.

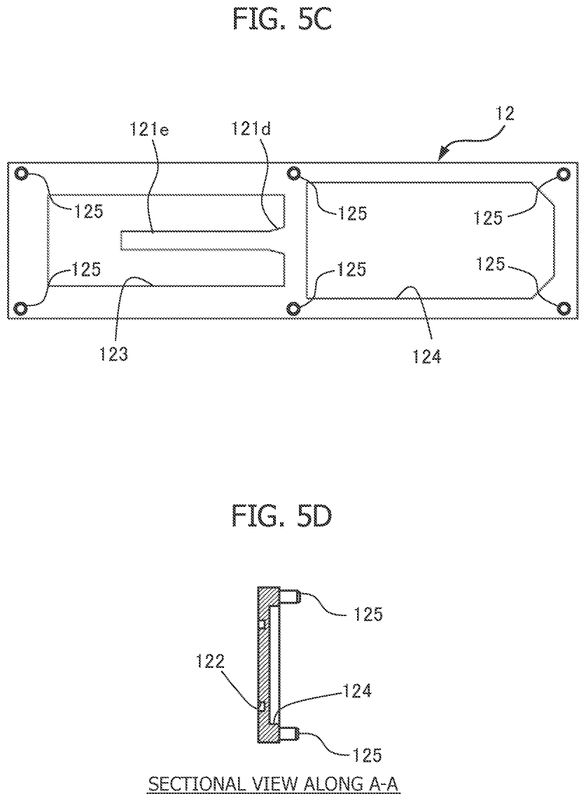

FIG. 5 illustrates the lower flow passage forming member 12. FIG. 5A is a top view of the lower flow passage forming member 12, FIG. 5B is a side view of the lower flow passage forming member 12, FIG. 5C is a bottom view of the lower flow passage forming member 12, and FIG. 5D is a sectional view along A-A in FIG. 5A.

In the present embodiment, the lower flow passage forming member 12 is made of a transparent synthetic resin similarly to the upper flow passage forming member 11 and is formed to have flexibility to some extent. Also, the lower flow passage forming member 12 is preferably configured with a molded article of a transparent synthetic resin. Although the lower flow passage forming member 12 is preferably formed by the same synthetic resin as that of the upper flow passage forming member 11, the lower flow passage forming member 12 may be formed by a different synthetic resin. Although not particularly limited, the contact angle of the surface of the lower flow passage forming member 12 is preferably not more than 90 degrees with respect to water similarly to that of the upper flow passage forming member 11.

Referring to FIGS. 5A to 5C, the lower flow passage forming member 12 is formed to have an outer shape with a rectangular shape in a top view so as to correspond to the upper flow passage forming member 11. Also, the lower wall portion 121 constituting the lower wall of the inner flow passage 3 is formed at the lower flow passage forming member 12 so as to correspond to the inlet 2 and the upper wall portion 111 formed at the upper flow passage forming member 11. In other words, the lower wall portion 121 is formed to be located below the inlet 2 and the upper wall portion 111 in the upper flow passage forming member 11 when the upper flow passage forming member 11, the lower flow passage forming member 12, and the intermediate member 13 are stacked. The lower wall portion 121 extends from the one end toward the other end in the longitudinal direction L similarly to the upper wall portion 111.

In the present embodiment, the lower wall portion 121 includes a semicircular portion 121a, a lower tapered portion 121b, a first lower straight portion 121c, a lower narrowed width portion 121d, and a second lower straight portion 121e in this order from the one end in the longitudinal direction L.

The semicircular portion 121a is a part corresponding to the inlet 2 of the upper flow passage forming member 11. The semicircular portion 121a is concentric with the inlet 2 of the upper flow passage forming member 11 illustrated by the two-dotted chain line in FIG. 5A and has a larger diameter than the inlet 2.

The lower tapered portion 121b is a part corresponding to the upper tapered portion 111a of the upper flow passage forming member 11. The lower tapered portion 121b extends from the semicircular portion 121a toward the other end in the longitudinal direction L. Also, the lower tapered portion 121b is formed into a tapered shape with a width gradually narrowed at a greater distance from the semicircular portion 121a. The lower tapered portion 121b is designed to be able to overlap the upper tapered portion in a top view and has the same taper angle as the taper angle of the upper tapered portion 111a.

The first lower straight portion 121c is a part corresponding to the first upper straight portion 111b of the upper flow passage forming member 11. The first lower straight portion 121c has the same width as that of the distal end portion of the lower tapered portion 121b and linearly extends from the distal end portion of the lower tapered portion 121b toward the other end in the longitudinal direction L. The first lower straight portion 121c has the same width as that of the first upper straight portion 111b.

Here, in the present embodiment, a recessed groove portion 122 with a substantially U shape having an open portion facing the other end in the longitudinal direction L is formed in an upper surface on a side closer to the one end in the longitudinal direction L than the center of the lower flow passage forming member 12 in the longitudinal direction L. Also, the inner part of the recessed groove portion 122 in the lower flow passage forming member 12 constitutes the semicircular portion 121a, the lower tapered portion 121b, and the first lower straight portion 121c.

The lower narrowed width portion 121d refers to a part corresponding to the upper narrowed width portion 111c of the upper flow passage forming member 11 and a part where the width of the lower wall portion 121 is narrowed. In the present embodiment, the lower narrowed width portion 121d couples the first lower straight portion 121c to the second lower straight portion 121e. Specifically, the second lower straight portion 121e is formed to have a narrower width than the first lower straight portion 121c and the same width as that of the second upper straight portion 111d of the upper flow passage forming member 11 in the present embodiment. Also, the lower narrowed width portion 121d is formed into a tapered shape in which the width is gradually narrowed from the width of the first lower straight portion 121c to the width of the second lower straight portion 121e, and couples the first lower straight portion 121c to the second lower straight portion 121e. The lower narrowed width portion 121d has the same taper angle as the taper angle of the upper narrowed width portion 111c. Note that in a case where the upper narrowed width portion 111c is configured to have a shape with one or more steps or a plurality of tapered shapes, for example, the lower narrowed width portion 121d is also configured to have a shape with one or more steps or a plurality of tapered shapes accordingly.

The second lower straight portion 121e is a part corresponding to the second upper straight portion 111d of the upper flow passage forming member 11. The second lower straight portion 121e is formed to have a narrower width (with the same width as that of the second upper straight portion 111d) than the first lower straight portion 121c and linearly extends from the lower narrowed width portion 121d toward the other end in the longitudinal direction L.

Here, a bored hole 123 with a substantially U shape having an open portion facing the one end in the longitudinal direction L is formed on the side closer to the other end in the longitudinal direction L than the center of the lower flow passage forming member 12 in the longitudinal direction L. Also, the inner part of the bored hole 123 in the lower flow passage forming member 12 constitutes the lower narrowed width portion 121d and the second lower straight portion 121e. Note that the upper surfaces of the lower narrowed width portion 121d and the lower straight portion 121e are inclined such that the height positions thereof are gradually lowered at a greater distance from the distal end portion of the first lower straight portion 121c. As will be described later, the lower narrowed width portion 121d and the second lower straight portion 121e constitute the lower wall of the separating flow passage 32. Therefore, the inclination angle of the upper surfaces of the lower narrowed width portion 121d and the second lower straight portion 121e are set within a range of 1° to 45°, preferably 2° to 10° with respect to the horizontal direction. Also, a part of the bored hole 123 at the other end in the longitudinal direction L constitutes the housing space 5 where the first liquid absorbing material 4 is housed.

Also, a recessed portion 124 is formed in a lower surface on the side closer to the one end in the longitudinal direction L than the center of the lower flow passage forming member 12 in the longitudinal direction L. The recessed portion 124 has a size with which it can include at least a most part of the lower tapered portion 121b of the lower wall portion 121 in a top view. A back plate 15, which will be described later, is housed in the recessed portion 124.

Furthermore, a plurality of (six here) pins 125 are provided to project at intervals therebetween in a peripheral edge portion of the lower surface of the lower flow passage forming member 12. Note that although the six pins 125 are provided here, the number of the pins 125 may be freely set.

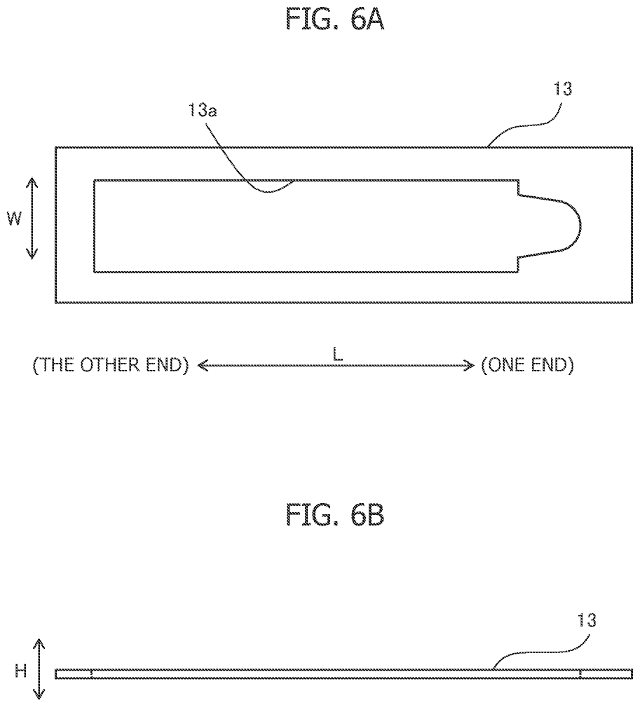

FIG. 6 illustrates the intermediate member 13. FIG. 6A is a top view of the intermediate member 13, and FIG. 6B is a side view of the intermediate member 13.

Referring to FIGS. 6A and 6B, the intermediate member 13 is formed to have a rectangular outer shape in a top view so as to correspond to the upper flow passage forming member 11 and the lower flow passage forming member 12. The intermediate member 13 has a small dimension in the height direction H (that is, the thickness) and has a second opening portion 13a that penetrates through the intermediate member 13 in the height direction H therein. The dimension (the thickness) of the intermediate member 13 in the height direction H may be set in accordance with the required height of the microflow passage 31. The second opening portion 13a has a size with which it is possible to include the inlet 2, the upper wall portion 111, the pair of first opening portions 112 and 112, and the through-holes 113 and 113 formed in the upper flow passage forming member 11 therein in a top view. Also, the upper surface and the lower surface of the intermediate member 13 are formed as members with adhesiveness. In one example, the intermediate member 13 may be formed by disposing double-sided adhesive sheets on an upper surface and a lower surface of a sheet material. In this case, it is possible to freely change the dimension of the intermediate member 13 in the height direction H, that is, the height of the microflow passage 31 by appropriately selecting the sheet material with any thickness, for example. Also, the intermediate member 13 may be any intermediate member as long as a liquid does not penetrate into at least a part functioning as a spacer (spacer portion), and it is also possible to freely change the shape and the type of the intermediate member 13.

Also, the upper flow passage forming member 11, the lower flow passage forming member 12, and the intermediate member 13 are stacked and integrated by the lower surface of the upper flow passage forming member 11 being joined to the upper surface of the intermediate member 13 and by the upper surface of the lower flow passage forming member 12 being joined to the lower surface of the intermediate member 13, and the inner flow passage 3 and the inner ventilation space 7 are thereby formed. Here, in an actual assembly, the lower absorbing material 4b of the first liquid absorbing material 4 is housed at a predetermined position (housing space 5) in the bored hole 123 of the lower flow passage forming member 12 when the upper flow passage forming member 11, the lower flow passage forming member 12, and the intermediate member 13 are integrated.

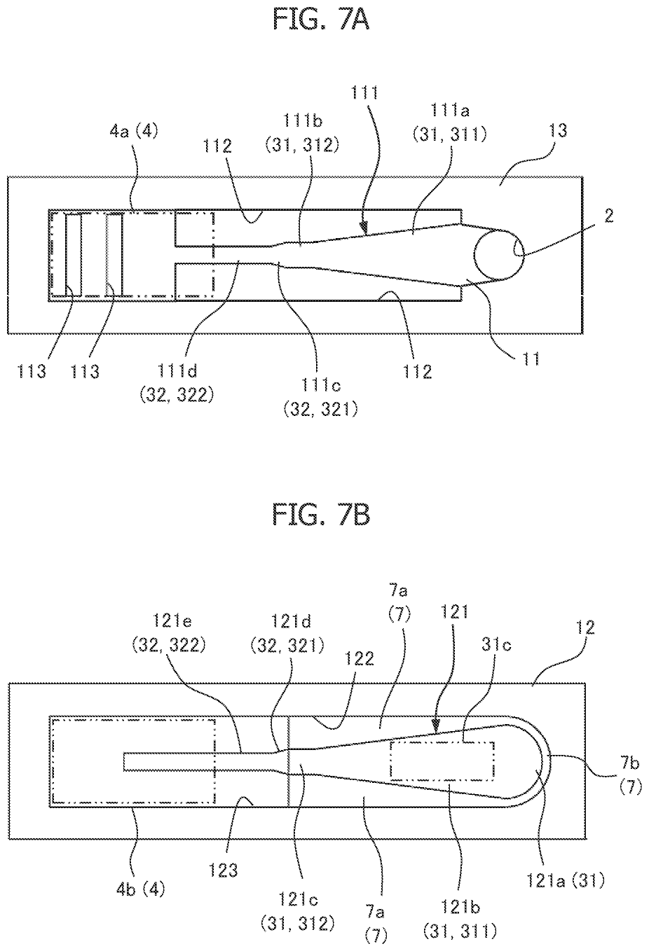

FIG. 7 is a diagram for explaining the inner flow passage 3 and the inner ventilation space 7. FIG. 7A is a diagram of the upper flow passage forming member 11 and the intermediate member 13 seen from the side of the lower flow passage forming member 12 and mainly illustrates an upper portion of the inner flow passage 3. FIG. 7B is a diagram of the lower flow passage forming member 12 from the side of the intermediate member 13 and mainly illustrates a lower portion of the inner flow passage 3. Note that the two-dotted chain lines in the drawing illustrate the first liquid absorbing material 4 (the upper absorbing material 4a and the lower absorbing material 4b) and the assay region 31c.

In the present embodiment, the upper tapered portion 111a and the first upper straight portion 111b of the upper wall portion 111 of the upper flow passage forming member 11 constitute the upper wall of the microflow passage 31 in the inner flow passage 3, and the semicircular portion 121a, the lower tapered portion 121b, and the first lower straight portion 121c of the lower wall portion 121 of the lower flow passage forming member 12 constitute the lower wall of the microflow passage 31 in the inner flow passage 3. Moreover, the upper narrowed width portion 111c and the second upper straight portion 111d of the upper wall portion 111 of the upper flow passage forming member 11 constitute the upper wall of the separating flow passage 32 in the inner flow passage 3, and the lower narrowed width portion 121d and the second lower straight portion 121e of the lower wall portion 121 of the lower flow passage forming member 12 constitute the lower wall of the separating flow passage 32 in the inner flow passage 3.

In other words, the microflow passage 31 is formed as a flow passage that includes the tapered flow passage portion 311 extending from the position corresponding to the inlet 2, that is, the position below the inlet 2 at which it is possible to receive the liquid injected from the inlet 2 toward the separating flow passage 32 and having a flow passage width gradually narrowed at a greater distance from the inlet 2. More specifically, the microflow passage 31 is formed as a flow passage including a tapered flow passage portion 311 and a first straight flow passage portion 312 extending from the distal end portion of the tapered flow passage portion 311, reaching the separating flow passage 32, and having a constant flow passage width in the present embodiment. Here, the tapered flow passage portion 311 is defined by the upper tapered portion 111a and the lower tapered portion 121b and has a taper angle of 1° to 20°, preferably of 2° to 16°. Also, the first straight flow passage portion 312 is defined by the first upper straight portion 111b and the first lower straight portion 121c. Note that although not particularly limited, the flow passage width near an inlet of the microflow passage 31 (that is, in the vicinity of the inlet 2) may be, for example, equal to or greater than 2 mm and equal to or less than 10 mm, or preferably equal to or greater than 4 mm and equal to or less than 10 mm, and the flow passage width near an outlet of the microflow passage 31 (that is, in the vicinity of the separating flow passage 32) may be equal to or greater than 1 mm and equal to or less than 6 mm, or preferably equal to or greater than 3 mm and equal to or less than 6 mm.

Also, the separating flow passage 32 includes a narrowed width portion 321 formed as a flow passage extending from the microflow passage 31 toward the first liquid absorbing material 4 and having a narrowed flow passage width. The narrowed width portion 321 is provided successively from or in adjacent to the microflow passage 31. Here, the narrowed width portion 321 being provided in adjacent to the microflow passage 31 means that the microflow passage 31 being provided right next to the microflow passage 31 and includes a case where a part that does not extremely affect a flow of the liquid is interposed between the microflow passage 31 and the narrowed width portion 321. More specifically, in the present embodiment, the separating flow passage 32 is formed as a flow passage including the narrowed width portion 321 provided successively from or adjacent to the microflow passage 31 and a second straight flow passage portion 322 extending from the narrowed width portion 321, reaching the first liquid absorbing material 4, and having a narrower flow passage width than the first straight flow passage portion 312 of the microflow passage 31 in the present embodiment. Also, in the present embodiment, the narrowed width portion 321 is formed into a tapered shape with a flow passage width gradually narrowed from the flow passage width of the first straight flow passage portion 312 of the microflow passage 31 to the flow passage width of the second straight flow passage portion 322. Also, the lower wall of the separating flow passage 32 is inclined downward such that the height position is lowered toward the first liquid absorbing material 4. Here, the narrowed width portion 321 is defined by the upper narrowed width portion 111c and the lower narrowed width portion 121d, and the second straight flow passage portion 322 is defined by the second upper straight portion 111d and the second lower straight portion 121e. Note that although not particularly limited, the flow passage width near the inlet of the narrowed width portion 321 may be the same as the flow passage width near the outlet of the microflow passage 31. In other words, the flow passage width near the inlet of the narrowed width portion 321 may be, for example, equal to or greater than 1 mm and equal to or less than 6 mm, or preferably equal to or greater than 3 mm and equal to or less than 6 mm. Also, the flow passage width near the outlet of the narrowed width portion 321 may be, for example, equal to or greater than 0.5 mm and equal to or less than 5 mm, or preferably equal to or greater than 1 mm and equal to or less than 4 mm.

Furthermore, the inner ventilation space 7 (the sideways spaces 7a and 7a and the coupling space 7b) are formed by the recessed groove portion 122 with a substantially U shape formed in the upper surface on the side closer to the one end in the longitudinal direction L than the center of the lower flow passage forming member 12 in the longitudinal direction L and a space above the recessed groove portion 122. Also, the pair of first opening portions 112 and 112 formed in the upper flow passage forming member 11 are located above the sideways spaces 7a and 7a of the inner ventilation space 7 and communicate with the sideways spaces 7a and 7a.

Next, other configurations of the assay device 1 will be described with reference to FIGS. 1 to 3.

The assay device 1 further includes an upper cover 14, a back plate 15, a second liquid absorbing material 16, and a lower case 17 in addition to the first liquid absorbing material 4 (the upper absorbing material 4a and the lower absorbing material 4b), the upper flow passage forming member 11, the lower flow passage forming member 12, and the intermediate member 13 described above.

The upper cover 14 is made of a synthetic resin, for example, and is formed into a flat plate shape. Preferably, the upper cover 14 is configured with a molded article of a synthetic resin. The upper cover 14 is attached to (caused to adhere to) the upper surface of (the thin portion 11b of) the upper flow passage forming member 11 via a double-sided adhesive sheet 18 formed into substantially the same shape as that of the upper cover 14.

Ventilation holes 141 and 141 that cause the inner ventilation space 7 to communicate with the outside are formed in the upper cover 14. The ventilation holes 141 and 141 are disposed above the pair of first opening portions 112 and 112 in the upper flow passage forming member 11 communicating with the inner ventilation space 7 (sideways spaces 7a and 7a).

Also, observation windows 142 and 142 for an observer to observe (a detectable result occurring in) the assay region 31c in the microflow passage 31 are formed in the upper cover 14. The observation windows 142 and 142 are disposed above the assay region 31c in the microflow passage 31, more specifically, above the first assay reagent 6a and the second assay reagent 6b.

Furthermore, checking/ventilation windows 143 and 143 for causing the housing space 5 that houses the first liquid absorbing material 4 to communicate with the outside and checking a state (such as a liquid absorbing condition) of the first liquid absorbing material 4 are formed in the upper cover 14. The checking/ventilation windows 143 and 143 are disposed above the first liquid absorbing material 4 and above the two through-holes 113 and 113 in the upper flow passage forming member 11.

The back plate 15 is made of a white or black synthetic resin and is preferably configured with a molded article of a synthetic resin. The back plate 15 is housed in the recessed portion 124 formed in the lower surface of the lower flow passage forming member 12. As described above, the upper flow passage forming member 11 and the lower flow passage forming member 12 forming the inner flow passage 3 are formed to be transparent in the present embodiment. Also, the recessed portion 124 formed in the lower surface of the lower flow passage forming member 12 has a size with which a most part of the lower tapered portion 121b of the lower wall portion 121 constituting the lower wall of the microflow passage 31 is included therein. Therefore, the back plate 15 is disposed below the assay region 31c of the microflow passage 31 by being housed in the recessed portion 124 formed in the lower surface of the lower flow passage forming member 12. Also, the back plate 15 housed in the recessed portion 124 provides a white or black background to the assay region 31c to thereby make it easier for the observer to observe (the detectable result occurring in) the assay region 31c through the observation windows 142 and 142.

Therefore, the color of the back plate 15 is preferably appropriately selected in accordance with the detectable result to occur in the assay region 31c. For example, a white back plate 15 is selected in a case where it is necessary for the observer to observe coloring, light absorbance, and the like through the observation windows 142 and 142, or a black back plate 15 is selected in a case where it is necessary for the observer to observe light emission, fluorescence, and the like through the observation windows 142 and 142.

The second liquid absorbing material 16 is formed by a porous material capable of absorbing a liquid similarly to the first liquid absorbing material 4. The second liquid absorbing material 16 is formed to be larger than the first liquid absorbing material 4 and is disposed below the first liquid absorbing material 4 and the lower flow passage forming member 12. The second liquid absorbing material 16 mainly absorbs the liquid via the first liquid absorbing material 4.

The lower case 17 is made of a synthetic resin, for example, and is preferably configured with a molded article of a synthetic resin. The lower case 17 includes an accommodating portion 171 of an upper surface opening for housing the second liquid absorbing material 16 and a support surface 172 that supports the lower surface of the back plate 15 housed in the recessed portion 124 formed in the lower surface of the lower flow passage forming member 12. Also, six pin holes 173 into which the six pins 125 provided to project from the lower surface of the lower flow passage forming member 12 are fitted are formed at a peripheral edge portion of the upper surface of the lower case 17.

Next, an example of a method (manufacturing method) of assembling the assay device 1 will be briefly described. Note that in the present embodiment, the first assay reagent 6a and the second assay reagent 6b are fixed at prescribed positions in (the upper tapered portion 111a of) the upper wall portion 111 of the upper flow passage forming member 11 and/or (the lower tapered portion 121b of) the lower wall portion 121 of the lower flow passage forming member 12, that is, are disposed in the assay region 31c using a known fixation technology or the like, and description herein will be omitted.

First, the second liquid absorbing material 16 is housed in the accommodating portion 171 of the lower case 17.

Then, the lower flow passage forming member 12 is attached to the lower case 17 by fitting the pins 125 of the lower flow passage forming member 12 into the pin holes 173 of the lower case 17. At that time, the lower absorbing material 4b of the first liquid absorbing material 4 is housed in the other end in the longitudinal direction L (housing space 5) of the bored hole 123 of the lower flow passage forming member 12, and the back plate 15 is housed in the recessed portion 124 formed in the lower surface of the lower flow passage forming member 12. Here, the lower flow passage forming member 12 may be attached to the lower case 17 using a double-sided adhesive sheet or the like instead of or in addition to the fitting between the pins 125 and the pin holes 173 although illustration is omitted.

Then, the upper absorbing material 4a of the first liquid absorbing material 4 is housed in the other end in the longitudinal direction L (housing space 5) of the bored hole 123 of the lower flow passage forming member 12. In other words, the upper absorbing material 4a is placed on the lower absorbing material 4b.

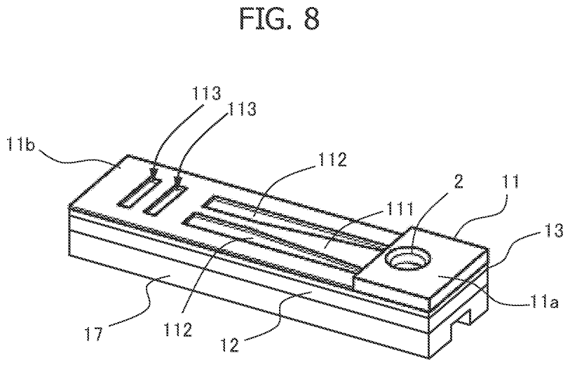

Then, the intermediate member 13 and the upper flow passage forming member 11 are positioned and placed on the lower flow passage forming member 12. In other words, the lower surface (adhesive surface) of the intermediate member 13 is joined to the upper surface of the lower flow passage forming member 12, and the lower surface of the upper flow passage forming member 11 is joined to the upper surface (adhesive surface) of the intermediate member 13. Alternatively, the upper flow passage forming member 11 is joined to the upper surface of the intermediate member 13 first, and the lower surface of the intermediate member 13 is then joined to the upper surface of the lower flow passage forming member 12. In this manner, the upper flow passage forming member 11, the lower flow passage forming member 12, and the intermediate member 13 are integrated in a stacked state, and the inner flow passage 3 and the inner ventilation space 7 are thereby formed. The state at this time is illustrated in FIG. 8.

Then, a blocking treatment is performed on the inner flow passage 3. In the present embodiment, a predetermined amount of blocking agent is injected into the inlet 2 in a dropwise manner, and incubation is then performed for a predetermined period of time (1 hour, for example). Although the blocking agent to be used is not particularly limited, the blocking agent may be a diluted solution or an undiluted solution of the aforementioned commercially available blocking agent. Here, since the blocking agent may lower the interfacial tension of the liquid inside the microflow passage 31, excess blocking agent in the injected blocking agent is preferably removed.

In this regard, in the present embodiment, the pair of first opening portions 112 and 112 formed in the upper flow passage forming member 11 are exposed in the upper surface when the blocking treatment is performed on the inner flow passage 3 as illustrated in FIG. 8. The pair of first opening portions 112 and 112 are located above and communicate with the sideways spaces 7a and 7a of the inner ventilation space 7, and the sideways spaces 7a and 7a of the inner ventilation space 7 are adjacent to the microflow passage 31 on both sides of the microflow passage 31 in the width direction and communicate with the microflow passage 31. Therefore, it is possible to easily and effectively remove the excess blocking agent by inserting a distal end nozzle of a suctioning machine or the like into the first opening portion 112 and performing suctioning.

Then, once the blocking treatment on the inner flow passage 3 ends, the upper cover 14 is attached (is caused to adhere) to the upper surface of the thin portion 11b of the upper flow passage forming member 11 using a double-sided adhesive sheet 18 or the like. In this manner, the assay device 1 is completed (see FIG. 1).

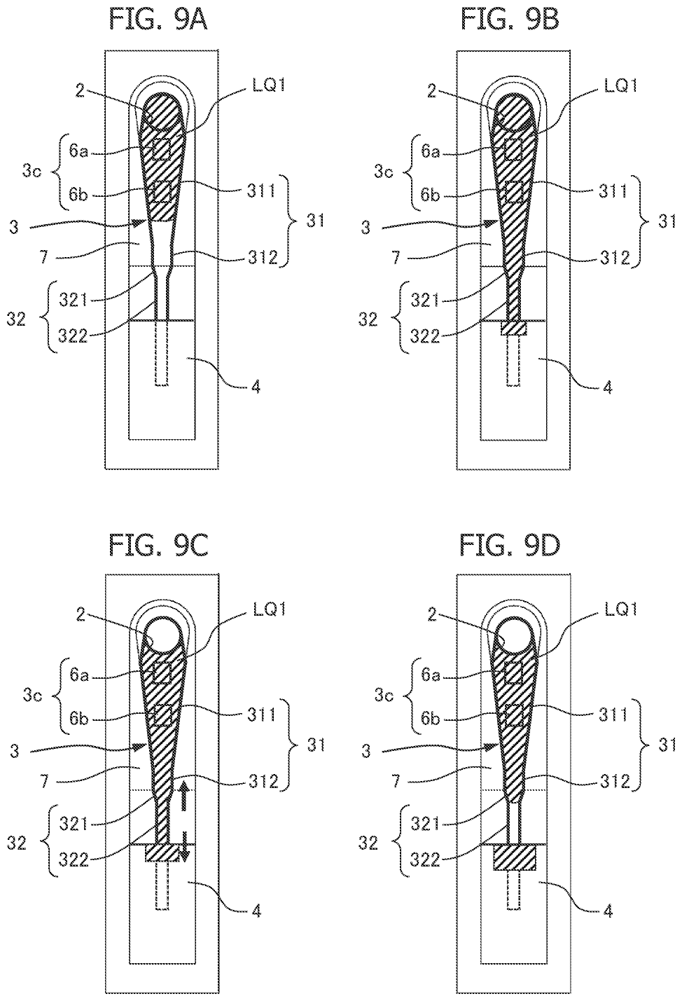

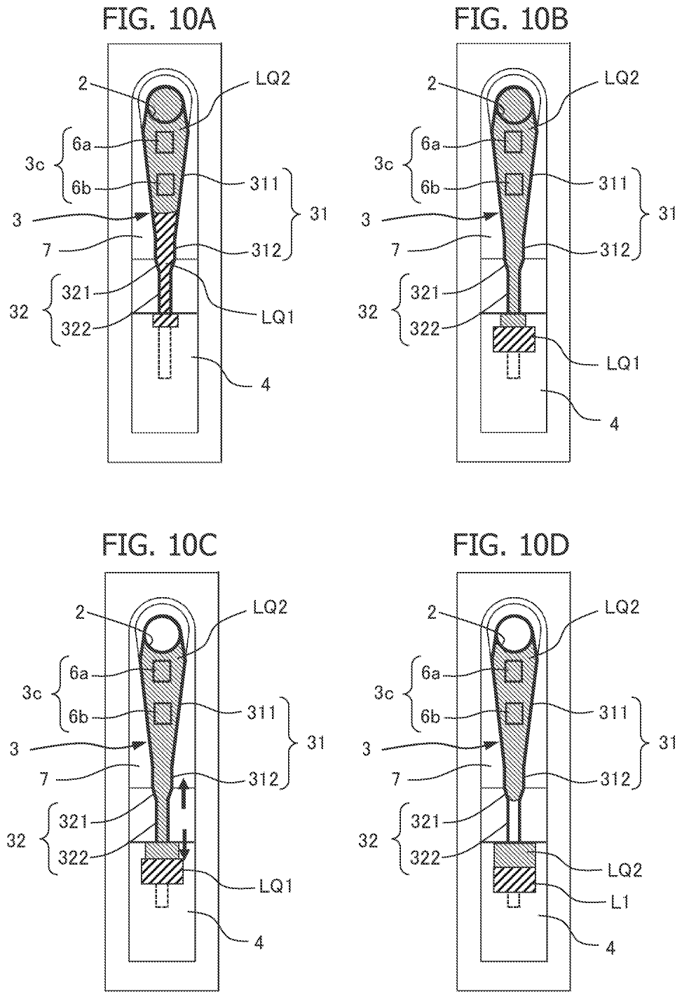

Next, motion of a liquid in the assay device 1 will be described with reference to FIGS. 9 and 10.

FIG. 9 is a diagram for explaining motion of the liquid injected to the assay device 1 (hereinafter, referred to as a “first liquid LQ1”) and schematically illustrates the inner flow passage 3 and the like when the assay device 1 is seen from above. Note that the first liquid LQ1 is hatched in FIG. 9.

Once the first liquid LQ1 is injected from the inlet 2, the first liquid LQ1 enters (is supplied to) the microflow passage 31 as illustrated in FIG. 9A. Here, the microflow passage 31 includes a tapered flow passage portion 311 with a flow passage width gradually narrowed from the vicinity of the inlet 2 toward the separating flow passage 32. Therefore, the first liquid LQ1 that has entered the microflow passage 31 smoothly flows toward the separating flow passage 32.

Once the injection of the first liquid LQ1 is continued, and the first liquid LQ1 in amount exceeding the capacity of the microflow passage 31 is supplied to the microflow passage 31, the first liquid LQ1 flows into the separating flow passage 32. Here, the lower wall of the separating flow passage 32 is inclined downward such that the height position is lowered as it approaches the first liquid absorbing material 4. Therefore, the first liquid LQ1 that has flowed into the separating flow passage 32 flows through the separating flow passage 32 toward the first liquid absorbing material 4 and comes into contact with the first liquid absorbing material 4 as illustrated in FIG. 9B. Then, the first liquid LQ1 is absorbed by the first liquid absorbing material 4 due to a capillary force of the first liquid absorbing material 4.

Thereafter, once the injection of the first liquid LQ1 is stopped, the first liquid LQ1 in the inlet 2 flows through the microflow passage 3 (toward the liquid absorbing material 4), and the flowing of the first liquid LQ1 inside the microflow passage 31 into the separating flow passage 32 is then stopped. At this time, since the capillary force of the first liquid absorbing material 4 acts on the first liquid LQ1, a state where the first liquid LQ1 is pulled between the microflow passage 31 and the first liquid absorbing material 4 is achieved as illustrated by the arrow in FIG. 9C.

Here, the separating flow passage 32 located between the microflow passage 31 and the first liquid absorbing material 4 includes the narrowed width portion 321 with a narrowed flow passage width in the present embodiment. Also, the narrowed width portion 321 is provided successively from or adjacent to the microflow passage 31. Therefore, the first liquid LQ1 inside the microflow passage 31 on the side upstream the narrowed width portion 321 is strongly caused to stay in the microflow passage 31 due to an interfacial tension, and flowing of the first liquid LQ1 inside the microflow passage 31 across the narrowed width portion 321 to the downstream side is inhibited. On the other hand, the first liquid LQ1 on the side downstream the narrowed width portion 321 is suctioned due to the capillary force of the first liquid absorbing material 4. As a result, the first liquid LQ1 inside the inner flow passage 3 is divided by the narrowed width portion 321 of the separating flow passage 32, a part thereof (the part located on the side downstream the narrowed width portion 321) is absorbed by the first liquid absorbing material 4, and the rest is left on the side upstream the narrowed width portion 321, that is, mainly inside the microflow passage 31, as illustrated in FIG. 9D. In this manner, the first liquid LQ1 inside the inner flow passage 3 is separated into a part absorbed by the first liquid absorbing material 4 and a part left inside the microflow passage 31. In this manner, even the first liquid LQ1 with a small (weak) interfacial tension is not suctioned from the microflow passage 31 to the first liquid absorbing material 4 due to the capillary force of the first liquid absorbing material 4 by the narrowed width portion 321 being provided in the separating flow passage 32 in the present embodiment. As a result, it is possible to stably divide the first liquid LQ1 inside the inner flow passage 3 by the separating flow passage 32, in other words, it is possible to cause the first liquid LQ1 to stably stay inside the microflow passage 31. Then, the detectable result occurs by the first liquid LQ1 staying inside the assay region 31c and by the first assay reagent 6a and/or the second assay reagent 6b reacting with the first liquid LQ1 or a specimen contained therein. In other words, an assay is performed in the assay region 31c.

FIG. 10 is a diagram for explaining motion of the first liquid LQ1 and a new liquid (hereinafter, referred to as a “second liquid LQ2”) when the second liquid LQ2 is injected after the injection of the first liquid LQ1 into the assay device 1 is stopped, and schematically illustrates the inner flow passage 3 and the like when the assay device 1 is seen from above. In FIG. 10, the first liquid LQ1 is hatched in the same manner as in FIG. 9, and the second liquid LQ2 is hatched differently from the first liquid LQ1.

Once the second liquid LQ2 is injected after the injection of the first liquid LQ1 is stopped, the second liquid LQ2 enters (is supplied to) the microflow passage 31 and flows toward the separating flow passage 32 similarly to the case of the first liquid LQ1 as illustrated in FIG. 10A. Here, the first liquid LQ1 is left inside the microflow passage 31 as described above. The first liquid LQ1 left inside the microflow passage 31 is pushed out of the microflow passage 31 by the newly injected second liquid LQ2, flows through the separating flow passage 32, comes into contact with the first liquid absorbing material 4, and is absorbed by the first liquid absorbing material 4.

Once the injection of the second liquid LQ2 is continued, and the second liquid LQ2 in amount exceeding the volume of the microflow passage 3, in other words, the second liquid LQ2 in amount exceeding the amount of first liquid LQ1 left inside the microflow passage 31 is supplied to the microflow passage 31, all the first liquid LQ1 left inside the microflow passage 31 is pushed out of the microflow passage 31. As a result, the first liquid LQ1 is replaced with the second liquid LQ2 inside the microflow passage 31. In other words, liquid replacement is performed inside the microflow passage 31. Then, once the second liquid LQ2 is further injected, the second liquid LQ2 flows from the microflow passage 31 into the separating flow passage 32, and the second liquid LQ2 flows through the separating flow passage 32 toward the first liquid absorbing material 4 and comes into contact with the first liquid absorbing material 4. In this manner, the second liquid LQ2 is absorbed by the first liquid absorbing material 4 due to the capillary force of the first liquid absorbing material 4 subsequently from the first liquid LQ1.

Thereafter, once the injection of the second liquid LQ2 is stopped, the second liquid LQ2 in the inlet 2 flows through the microflow passage 3 (toward the liquid absorbing material 4), and the flowing of the second liquid LQ2 inside the microflow passage 31 into the separating flow passage 32 is then stopped. At this time, since the capillary force of the first liquid absorbing material 4 acts on the second liquid LQ2, a state where the second liquid LQ2 is pulled between the microflow passage 31 and the first liquid absorbing material 4 is achieved similarly to the case of the first liquid LQ1 as illustrated in FIG. 10C. Then, the second liquid LQ2 inside the microflow passage 31 on the side upstream the narrowed width portion 321 is strongly caused to stay in the microflow passage 31 due to the interfacial tension, and the flowing of the second liquid LQ2 inside the microflow passage 31 across the narrowed width portion 321 toward the downstream side is inhibited similarly to the case of the first liquid LQ1. On the other hand, the second liquid LQ2 on the side downstream the narrowed width portion 321 is suctioned due to the capillary force of the first liquid absorbing material 4. In this manner, the second liquid LQ2 inside the inner flow passage 3 is divided by the narrowed width portion 321 of the separating flow passage 32, a part thereof (a part on the side downstream the narrowed width portion 321) is absorbed by the first liquid absorbing material 4, and the rest is left on the side upstream the narrowed width portion 321, that is, mainly inside the microflow passage 31, as illustrated in FIG. 10D. Also, an assay is performed in the assay region 31c similarly to the case of the first liquid LQ1 by the second liquid LQ2 staying inside the microflow passage 31.

In this manner, the separating flow passage 32 is provided with the narrowed width portion 321 in the assay device 1, the liquid inside the inner flow passage 3 can be stably divided by the separating flow passage 32 after the injection of the liquid is stopped and can stably stay inside the microflow passage 31 even in a case of a liquid with a small (weak) interfacial tension. Liquid replacement is performed inside the microflow passage 31 by the new liquid (the second liquid LQ2, for example) being injected in amount exceeding the amount of liquid (the first liquid LQ1, for example) left inside the microflow passage 31 in the state where the liquid (the first liquid LQ1, for example) is left inside the microflow passage 31. In other words, it is possible to stably perform liquid replacement inside the microflow passage 31 even in the case of a liquid with a small (weak) interfacial tension according to the assay device 1. Also, such stable liquid replacement can facilitate causing of an antigen-antibody reaction in multiple stages by the ELISA method or the like.

According to the assay device 1 of the embodiment, the following effects are obtained.

In the assay device 1 according to the embodiment, the separating flow passage 32 includes the narrowed width portion 321 provided successively from or adjacent to the microflow passage 31 and having a narrowed flow passage width.

In the assay device 1, a state where the liquid is pulled between the microflow passage 31 and the first liquid absorbing material 4 is achieved after the liquid of the inlet 2 flows toward the first liquid absorbing material 4 once the injection of the liquid is stopped (see FIGS. 9C and 10C). At this time, the liquid inside the microflow passage 31 strongly tries to stay inside the microflow passage 31 due to its own interfacial tension due to presence of the narrowed width portion 321. Therefore, the liquid inside the microflow passage 31 being suctioned due to the capillary force of the first liquid absorbing material 4 and flowing out from the microflow passage 31 is curbed even in a case where the interfacial tension of the liquid is small. As a result, the liquid inside the inner flow passage 3 is stably divided by the narrowed width portion 321 of the separating flow passage 32 even in a case of a small interfacial tension, and it is possible to cause the liquid to stably stay inside the microflow passage 31. Therefore, there is substantially no concern that air is mixed into the microflow passage 31, replacement of the liquid inside the microflow passage 31 is stably performed, and the assay inside the microflow passage 31 can thus stably advance.

Here, a liquid that contains a relatively large amount of surfactant, for example, corresponds to the liquid with a small interfacial tension. The present inventors have confirmed from experiments that a liquid containing more surfactant as compared with the assay device in the related art is divided by the narrowed width portion 321 of the separating flow passage 32 and sufficiently stays inside the microflow passage 31 in the assay device 1 according to the embodiment. Some of them will be described as examples below.

In a case where the surfactant is polyoxyethylene sorbitan fatty acid ester such as Tween 20 (use concentration: 0.05 to 1 wt %), it was not possible to cause a liquid containing not less than 0.5 wt % of surfactant to sufficiently stay inside the microflow passage in the assay device in the related art in some cases. On the contrary, the assay device 1 according to the embodiment was able to cause even the liquid containing 5 to 10 wt % of surfactant to sufficiently stay inside the microflow passage 31. In other words, according to the assay device 1 of the embodiment, it is possible to perform an assay by suing the liquid containing the surfactant with causing no problems in actual utilization.

Also, in a case of polyoxyethylene alkylphenyl ether in which the surfactant was Triton X-100 (use concentration: 0.1 to 2.0 wt %), it was not possible to cause the liquid containing not less than 0.5 wt % of surfactant to sufficiently stay inside the microflow passage in the assay device in the related art in some cases. On the contrary, the assay device 1 according to the embodiment was able to cause even the liquid containing 2.0 wt % of surfactant to sufficiently stay inside the microflow passage 31. In other words, it is possible to perform an assay using a liquid containing the surfactant with no problems in actual utilization according to the assay device 1 of the present embodiment.

Furthermore, in a case where the surfactant was a polyethylene glycol-based surfactant such as PEIS-8 (polyethylene glycol monoisostearate), the assay device in the related art was not able to cause the liquid containing not less than 0.05 wt % of surfactant to sufficiently stay inside the microflow passage in some cases. On the contrary, the assay device 1 according to the embodiment was able to cause even the liquid containing 1.0 wt % of surfactant to sufficiently stay inside the microflow passage 31.

In short, it is possible to state that the assay device 1 according to the embodiment was able to perform an assay using a liquid containing not less than 1.0 wt % of surfactant, for which assay was not able to be stably performed in the assay device in the related art.

The microflow passage 31 in the assay device 1 according to the embodiment includes the tapered flow passage portion 311 extending from the vicinity of the inlet 2, more specifically, the position at which the liquid injected from the inlet 2 can be received, toward the separating flow passage 32 and having the flow passage width gradually narrowed at a greater distance from the inlet 2.

Therefore, the liquid injected from the inlet 2 can smoothy move toward the separating flow passage 32 inside the microflow passage 31, and a reaction or the like in the assay region 31c can be stably performed.

In the assay device 1 according to the embodiment, the narrowed width portion 321 of the separating flow passage 32 is formed into a tapered shape with a flow passage width gradually narrowed from the flow passage width of the first straight flow passage portion 312 of the microflow passage 31 to the flow passage width of the second straight flow passage portion 322 that is narrower than the flow passage width of the first straight flow passage portion 312.

Therefore, the stable dividing of the liquid inside the inner flow passage 3 by the narrowed width portion 321 is enabled, and staying and the like of the liquid in the narrowed width portion 321 are curbed.

In the assay device 1 according to the embodiment, the inner flow passage 3 (the microflow passage 31 and the separating flow passage 32) is formed by the upper flow passage forming member 11 in which the inlet 2 and the upper wall portion 111 constituting the upper wall of the inner flow passage 3 are formed, the lower flow passage forming member 12 in which the lower wall portion 121 constituting the lower wall of the inner flow passage 3 is formed, and the intermediate member 13 which functions as a spacer between the upper flow passage forming member 11 and the lower flow passage forming member 12 being stacked.

Therefore, it is possible to easily form the inner flow passage 3 with an appropriate height and thus to easily manufacture the assay device 1. Moreover, at least the upper flow passage forming member 11 and the lower flow passage forming member 12 may be configured with molded articles of a synthetic resin, and manufacturing cost is also thus reduced. Furthermore, since no seams are generated between the inlet 2 and the inner flow passage 3 (microflow passage 31) and in the middle of the inner flow passage 3, it is thus possible to reliably move the liquid injected into the inlet 2 to the inner flow passage 3 (microflow passage 31) and to move the liquid inside the inner flow passage 3.

In the assay device 1 according to the embodiment, the pair of sideways spaces 7a and 7a that are adjacent to and communicate with the microflow passage 31 are provided on both sides of the microflow passage 31 in the width direction W, and the pair of first opening portions 112 and 112 that are located above and communicate with the pair of sideways spaces 7a and 7a are formed in the upper flow passage forming member 11.

Therefore, it is possible to easily suction and remove excess blocking agent using the pair of first opening portions 112 and 112 when the blocking treatment is performed on the inner flow passage 3, for example. Therefore, degradation of the interfacial tension of the liquid inside the microflow passage 31 due to influences of the blocking agent can be curbed. Also, since the blocking agent can be suctioned from the pair of first opening portions 112 and 112, it is possible not to perform the blocking treatment on the separating flow passage 32. In this manner, the surface of the separating flow passage 32 does not become hydrophilic, and it thus becomes easy to stably divide the liquid inside the inner flow passage 3 by the separating flow passage 32.

In the assay device 1 according to the embodiment, the upper flow passage forming member 11 and the lower flow passage forming member 12 are transparent. Also, the assay device 1 according to the embodiment further includes the observation windows 142 and 142 provided above the assay region 31c of the microflow passage 31 for observing the assay region 31c from the outside and the white or black back plate 15 disposed below the assay region 31c of the microflow passage 31. More specifically, the observation windows 142 and 142 are disposed above the first assay reagent 6a and the second assay reagent 6b.

Therefore, the background of the assay region 31c may be white or black when the observer observes the assay region 31c with naked eyes or using a predetermined device through the observation windows 142 and 142. Therefore, even when the detectable result is a very weak signal (light emission, fluorescence, or the like), it is possible to relatively easily detect it.

Note that the microflow passage 31 includes the tapered flow passage portion 311 and the first straight flow passage portion 312 in the aforementioned embodiment. However, the microflow passage 31 is not limited thereto. The entire microflow passage 31 may be formed as a straight flow passage with a constant flow passage width.

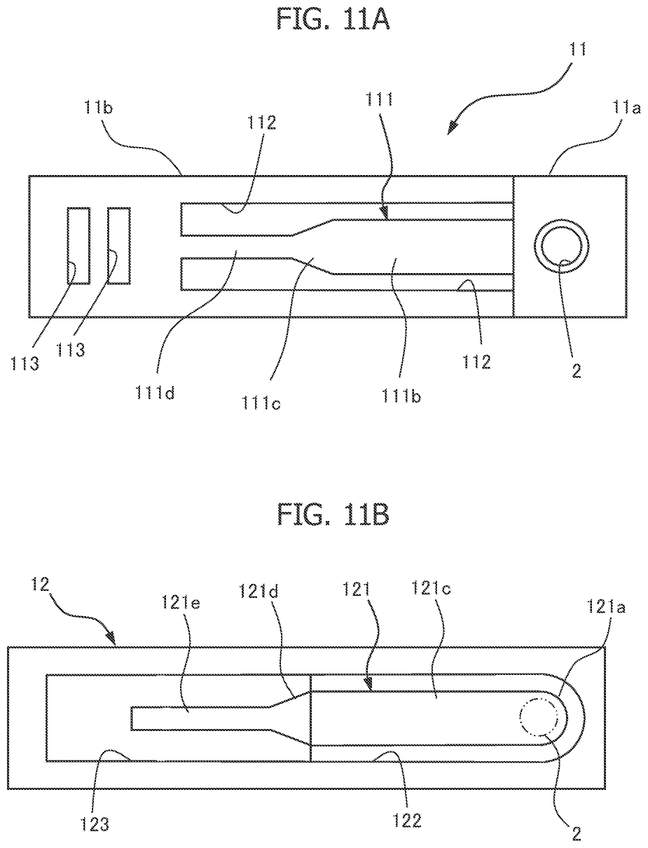

In this case, the upper tapered portion 111a is omitted in the upper wall portion 111 of the upper flow passage forming member 11, and the first upper straight portion 111b is formed to extend from the end portion of the thin portion 11b on the side of the thick portion 11a, that is, the vicinity of the inlet 2 toward the upper narrowed width portion 111c as illustrated in FIG. 11A corresponding to FIG. 4A. Also, the lower tapered portion 121b is omitted in the lower wall portion 121 of the lower flow passage forming member 12, and the first lower straight portion 121c is formed to extend from the semicircular portion 121a toward the lower narrowed width portion 121d as illustrated in FIG. 11B corresponding to FIG. 5A. Then, the first upper straight portion 111b of the upper wall portion 111 of the upper flow passage forming member 11 constitutes the upper wall of the microflow passage 31 in the inner flow passage 3, and the semicircular portion 121a and the first lower straight portion 121c of the lower wall portion 121 of the lower flow passage forming member 12 constitute the lower wall of the microflow passage 31 in the inner flow passage 3. Also, the upper narrowed width portion 111c and the second upper straight portion 111d of the upper wall portion 111 of the upper flow passage forming member 11 constitute the upper wall of the separating flow passage 32 in the inner flow passage 3, and the lower narrowed width portion 121d and the second lower straight portion 121e of the lower wall portion 121 of the lower flow passage forming member 12 constitute the lower wall of the separating flow passage 32 in the inner flow passage 3. In other words, the microflow passage 31 is defined by the first upper straight portion 111b and the first lower straight portion 121c, and the separating flow passage 32 includes the narrowed width portion defined by the upper narrowed width portion 111c and the lower narrowed width portion 121d and the straight flow passage portion defined by the second upper straight portion 111d and the second lower straight portion 121e.

Alternatively, the entire microflow passage 31 may be formed as a tapered flow passage. Although illustration is omitted, the first upper straight portion 111b is omitted in the upper wall portion 111 of the upper flow passage forming member 11, and the upper narrowed width portion 111c is formed to have a larger taper angle than the taper angle of the upper tapered portion 111a, for example, in this case. Similarly, the first lower straight portion 121c is omitted, and the lower narrowed width portion 121d is formed to have a larger taper angle than the taper angle of the lower tapered portion 121b, for example, in the lower wall portion 121 of the lower flow passage forming member 12.

Also, the narrowed width portion 321 of the separating flow passage 32 is provided successively from or adjacent to the microflow passage 31 in the aforementioned embodiment. However, the narrowed width portion 321 is not limited thereto. The narrowed width portion 321 of the separating flow passage 32 may be provided at a position separated from the microflow passage 31. However, from the viewpoint of efficiently replacing the liquid inside the microflow passage 31, the narrowed width portion 321 of the separating flow passage 32 is preferably provided successively from or adjacent to the microflow passage 31, or particularly preferably provided successively from the microflow passage 31 as in the aforementioned embodiment.

Furthermore, the upper flow passage forming member 11 and the lower flow passage forming member 12 are transparent, the observation windows 142 and 142 are provided above the assay region 31c of the microflow passage 31, and the white or black back plate 15 is disposed below the assay region 31c of the microflow passage 31 in the aforementioned embodiment. However, these are not limited thereto. The upper flow passage forming member 11 may be transparent, while the lower flow passage forming member 12 may be formed to be white or black. In other words, the upper flow passage forming member 11 may be formed by a transparent synthetic resin, and the lower flow passage forming member 12 may be formed by a white or black synthetic resin. In this case, the back plate 15 is not necessary. Also, the color of the lower flow passage forming member 12 is selected in accordance with the detectable result occurring in the assay region 31c similarly to the case of the back plate 15. In this manner, effects similar to those in the aforementioned embodiment are obtained.

### Second Embodiment

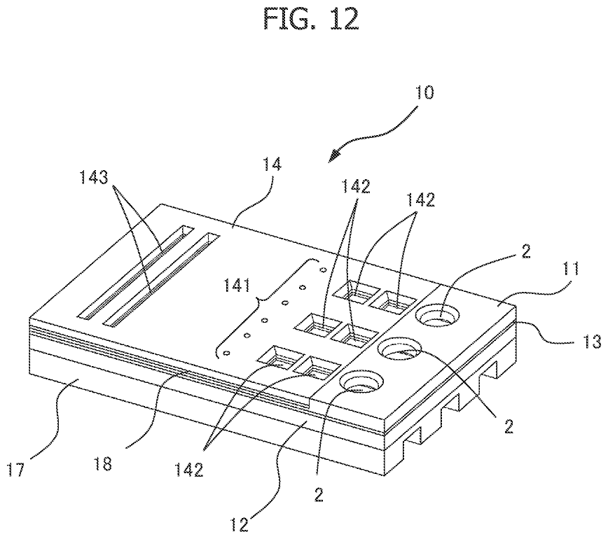

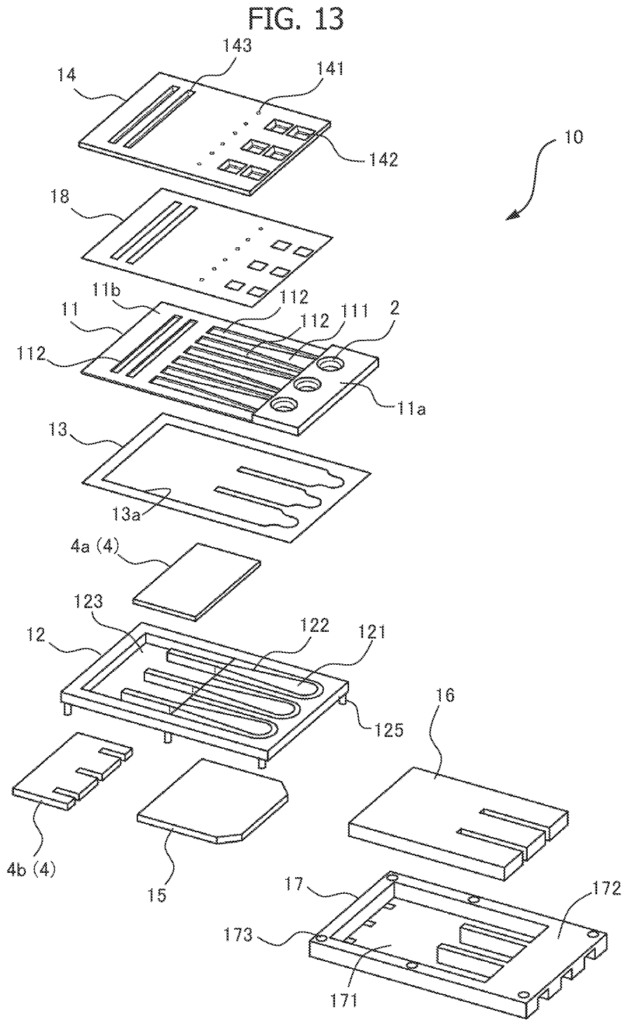

FIGS. 12 and 13 illustrate an assay device 10 according to a second embodiment. FIG. 12 is a perspective view of the assay device 10, and FIG. 13 is an exploded perspective view of the assay device 10. Note that elements in FIGS. 12 and 13 common to those in the assay device 1 according to the first embodiment will be denoted by the same reference signs and description thereof will be omitted.

Main differences between the assay device 1 according to the first embodiment and the assay device 10 according to the second embodiment are that while one inlet 2 and one inner flow passage 3 are provided in the assay device 1 according to the first embodiment, a plurality of (three here) inlets 2 and a plurality of inner flow passages 3 are provided in the assay device 10 according to the second embodiment, and the numbers of ventilation holes 141, observation windows 142, and the like provided are also increased accordingly. Other configurations are basically the same.

Effects similar to those of the assay device 1 according to the aforementioned first embodiment are obtained by the assay device 10 according to the second embodiment as well. Also, according to the assay device 10 of the second embodiment, it is possible to perform an assay on a plurality of liquids at the same time in a parallel manner. Note that the modification of the first embodiment can also be applied to the second embodiment.

Although the embodiments and modifications of the present invention have been described hitherto, it is a matter of course that the present invention is not limited to the aforementioned embodiments and modifications and changes can be made based on the technical concept of the present invention.

### REFERENCE SIGNS LIST

1,10 Assay device
2 Inlet
3 Inner flow passage
4 First liquid absorbing material
4a Upper absorbing material
4b Lower absorbing material
5 Housing space
6a First assay reagent
6b Second assay reagent
7 Inner ventilation space
7a Sideways space
7b Coupling space
11 Upper flow passage forming member
12 Lower flow passage forming member
13 Intermediate member
14 Upper cover
15 Back plate
16 Second liquid absorbing material
17 Lower case
31 Microflow passage
31c Assay region
32 Separating flow passage
111 Upper wall portion
121 Lower wall portion
142 Observation window
311 Tapered flow passage portion
312 First straight flow passage portion
321 Narrowed width portion
322 Second straight flow passage portion
LQ1 First liquid
LQ2 Second liquid

1. An assay device comprising:
an inlet;
an inner flow passage through which a liquid injected from the inlet flows; and
a liquid absorbing material that absorbs the liquid that has passed through the inner flow passage, wherein
the inner flow passage includes
a microflow passage including an assay region, and
a separating flow passage that is provided between the microflow passage and the liquid absorbing material for separating the liquid inside the inner flow passage when injection of the liquid is stopped, and
the separating flow passage has a narrowed width portion where a flow passage width is narrowed.

2. The assay device according to claim 1, wherein the narrowed width portion is provided successively from or adjacent to the microflow passage.

3. The assay device according to claim 1, wherein the microflow passage includes a tapered flow passage portion extending from a position at which the liquid injected from the inlet is able to be received toward the separating flow passage and having a flow passage width gradually narrowed at a greater distance away from the inlet.

4. The assay device according to claim 3, wherein
the microflow passage includes the tapered flow passage portion and a first straight flow passage portion extending from a distal end portion of the tapered flow passage portion, reaching the separating flow passage, and having a constant flow passage width,
the separating flow passage includes the narrowed width portion and a second straight flow passage portion extending from the narrowed width portion, reaching the liquid absorbing material, and having a constant flow passage width, which is narrower than the flow passage width of the first straight flow passage portion, and
the narrowed width portion is formed into a tapered shape having a flow passage width gradually narrowed from the flow passage width of the first straight flow passage portion to the flow passage width of the second straight flow passage width.

5. The assay device according to claim 1, wherein the inner flow passage is formed by an upper flow passage forming member, a lower flow passage forming member, and an intermediate member being stacked, the inlet and an upper wall portion constituting an upper wall of the inner flow passage being formed in the upper flow passage forming member, a lower wall portion constituting a lower wall of the inner flow passage being formed in the lower flow passage forming member, the intermediate member functioning as a spacer between the upper flow passage forming member and the lower flow passage forming member.

6. The assay device according to claim 5, wherein
a pair of sideways spaces that are adjacent to and communicate with the microflow passage are provided on both sides of the microflow passage in a width direction, and
a pair of openings that are located above and communicate with the pair of sideways spaces are formed at the upper flow passage forming member.

7. The assay device according to claim 5, wherein
the upper flow passage forming member and the lower flow passage forming member are transparent, and
the assay device further comprises:
an observation window that is provided above the assay region of the microflow passage for observing the assay region from outside; and
a white or black back plate that is disposed below the assay region of the microflow passage.

8. The assay device according to claim 5, wherein
the upper flow passage forming member is transparent,
the lower flow passage forming member is formed to be white or black, and
the assay device further comprises an observation window that is provided above the assay region of the microflow passage for observing the assay region from outside.

9. The assay device according to claim 1, wherein at least one assay reagent that reacts with a liquid or a sample contained therein is disposed in the assay region.

10. The assay device according to claim 1, wherein a plurality of the inlets and a plurality of the inner flow passages are included.
